(19) United States
(12) Patent Application Publication
(10) Pub. No.: US 2020/0198647 A1
(43) Pub. Date: Jun. 25, 2020

(54) METHOD FOR V2V COMMUNICATION FOR AERODYNAMICS

(71) Applicant: Toyota Motor Engineering & Manufacturing North America, Inc., Plano, TX (US)

(72) Inventors: Scott L. FREDERICK, Brighton, MI (US); Scott P. Robison, Dexter, MI (US); Paxton S. Williams, Milan, MI (US)

(73) Assignee: Toyota Motor Engineering & Manufacturing North America, Inc., Plano, TX (US)

(21) Appl. No.: 16/230,852

(22) Filed: Dec. 21, 2018

(51) Int. Cl. B60W 40/10; B60W 40/12; G07C 5/08; G07C 5/00; H04W 4/46; G05D 1/02

(52) U.S. Cl. CPC B60W 40/1005; B60W 40/12; G05D 1/0293; G07C 5/008; H04W 4/46; G07C 5/0808

(57) ABSTRACT

The present disclosure relates to a vehicle to vehicle aerodynamics system which communicates information among vehicles to determine aerodynamics of a vehicle and determine changes to the vehicles which may improve aerodynamics of the vehicle and/or overall aerodynamics of a group of vehicles.

### BACKGROUND

Vehicles have adopted several technologies to improve their aerodynamics, such as, spoilers, air dams, wheel shutter, etc. These parts can be fixed or mechanically operated to deploy when the need arises. Additionally, vehicles are adopting dedicated short range communications (DSRC) as a communication network providing information about nearby vehicles that may affect travel. Further, the use of autonomous vehicles and semi-autonomous vehicles becomes more common, information regarding the vehicles and related information regarding vehicle aerodynamics may be determined. Finally, as these autonomous and semi-autonomous vehicles are afforded greater control over various systems of a vehicle, the expansion into control of mechanically operated aerodynamics related systems may offer new opportunities for providing users of such vehicles with efficient use of resources.

The foregoing “Background” description is for the purpose of generally presenting the context of the disclosure. Work of the inventors, to the extent it is described in this background section, as well as aspects of the description which may not otherwise qualify as prior art at the lime of filing, are neither expressly or impliedly admitted as prior art against the present invention.

### SUMMARY

The present disclosure relates to a method, system, and a processing circuitry configured to communicate over a vehicle to vehicle (V2V) communications system; determine vehicle information; share aerodynamics information and vehicle information of the vehicle; determine an aerodynamics setting based on the aerodynamics information and the vehicle information; and adjust the vehicle based on the aerodynamics setting.

According to an embodiment, the present disclosure is further related to a processing circuitry configured to receive neighboring vehicle information and neighboring vehicle aerodynamics information; and determine the aerodynamics setting based on the aerodynamics information, the vehicle information, the neighboring vehicle information, and the neighboring vehicle aerodynamics information.

According to an embodiment, the present disclosure is further related to a processing circuitry configured to share updated aerodynamics information after adjustment of the vehicle; receive updated neighboring vehicle aerodynamics information; and determine an updated aerodynamics setting based on the updated aerodynamics information, the updated neighboring vehicle aerodynamics information, and the vehicle information

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a vehicle to vehicle ( V2V) communication system for vehicle aerodynamics according to one exemplary embodiment;

FIG. 2 is an exemplary block diagram of a server of V2V communication system for vehicle aerodynamics according to one exemplary embodiment;

FIG. 3 is a diagram illustrating vehicle aerodynamics according to one exemplary embodiment;

FIG. 4 is a diagram of a flowchart illustrating a flow of V2V communications for vehicle aerodynamics according to one exemplary embodiment;

FIG. 5 is a diagram of a processing circuitry configured to execute V2V communication for vehicle aerodynamics, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

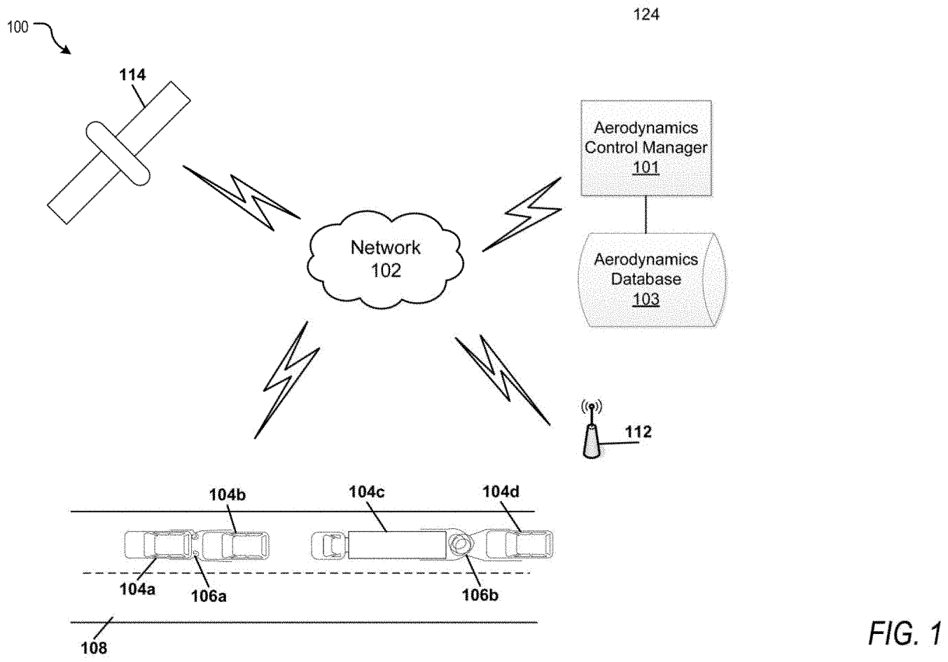

FIG. 1 is a schematic diagram of a V2V communication system for vehicle aerodynamics according to one exemplary embodiment. In FIG. 1, a server 101, providing a V2V communication system, may receive the data inputs from vehicles 104 on a roadway via a network 102. The vehicles 104 may transmit information about vehicle travel, environment, vehicle controls, and/or vehicle aerodynamics. The server 101 is further described as an aerodynamics control manager 101 which may include a device, application, or circuitry which is capable of accessing an aerodynamics database 103. In other embodiments, the aerodynamics control manager 101 is a component or unit of the same server 101 (hereinafter, the server 101 and aerodynamics control manager 101 may be used interchangeably for the same aerodynamics control manager). The aerodynamics database 103 may include information about the weather, road speeds/geometry, vehicle type, vehicle capabilities, vehicle aerodynamics, and the like.

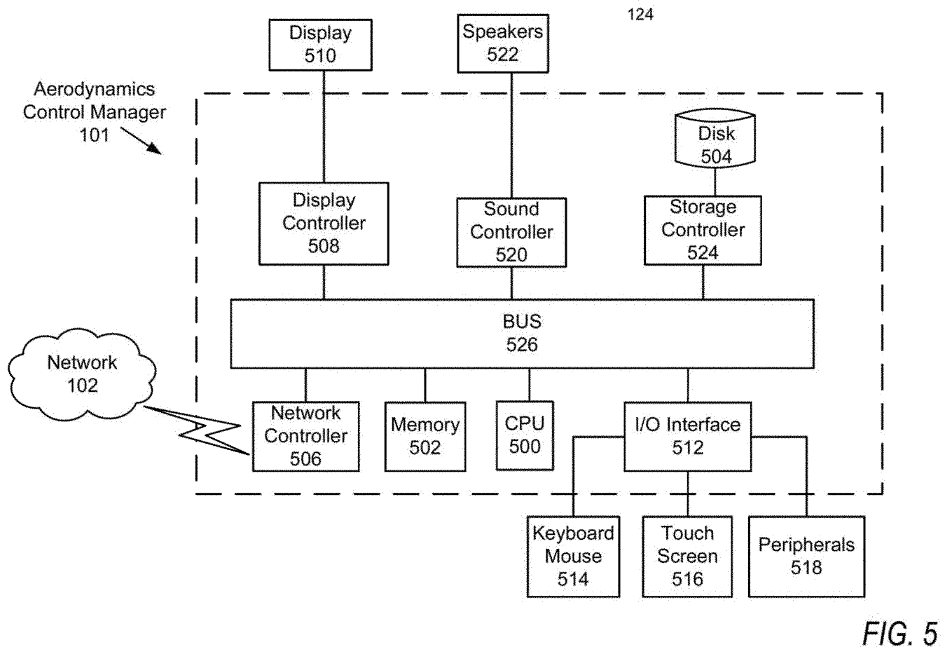

Each vehicle 104 may be provided access to server 101 via the network 102 or each vehicle 104 may include a server 101. Each vehicle 104 may be connected to the server 101 via the network 102 to communicate the data inputs and/or update and present information affecting the aerodynamics of the vehicle The server 101 is one or more servers that provide V2V communication services to vehicles. The network 102 may include conventional V2V communication over DSRC Suitable DSRC V2V communication networks may include VANETs (vehicular ad hoc networks). However, the network 102 may also include conventional communication services/networks that allow the vehicles 104 to communicate information with each other, such as over other computer networks. The network 102 may also include a V2V DSRC used in combination with the conventional communication services accessed by the vehicle 104. The server 101 includes a CPU 500 and a memory 502, as shown in FIG. 5.

Thus, the network 102 may include DSRC as well as the Internet or any other network capable of communicating data between devices and or vehicles. Suitable networks can include or interface with any one or more of a DSRC, local intranet, a PAN (Personal Area Network), a LAN (Local Area Network), a WAN (Wide Area Network), a MAN (Metropolitan Area Network), a VPN (Virtual Private Network), or a SAN (storage area network). Furthermore, communications may also include links to any of a variety of wireless networks, including WAP (Wireless Application Protocol), GPRS (General Packet Radio Service). GSM (Global system For Mobile Communication), CDMA (Code Division Multiple Access) or TDMA (Time Division Multiple Access), cellular phone networks, GPS (Global Positioning System), CDPD (Cellular digit packet data), Bluetooth radio, or an IEEE 802.11 based radio frequency.

The V2V communications system is capable of accessing sensors and devices effecting aerodynamics on vehicle 104 to both collect data about the vehicle, other vehicles, and environment effecting aerodynamics. These sensors may include LIDAR. RADAR, camera units, location detector, force/pressure sensors, thermometers, barometers, humidity determination, and the like. In other embodiments, sensors such as camera units from the passenger devices connected to the vehicle, such as mobile phones, may be used to collect data about other vehicles.

In one embodiment, the server 101 may use location information of vehicle 104 to determine the vehicle's geographical location. The location information of vehicle 104 can be determined via various satellite-based positioning systems known in the art, such as GPS (Global Positioning System). For example, the vehicle 104 may include a location detector. The location detector may be a GPS module for detecting a current geographical location of the vehicle. FIG. 1 shows a satellite 114. In one embodiment, the vehicle's location is determined via a cellular tower 112 with which communication has been established using current technology such as GMS (Global System for Mobile) localization, triangulation, Bluetooth, hotspots, WiFi detection, or other methods as would be understood by one of ordinary skill in the an. In one embodiment, the location of vehicle 104 is determined by the network 102. In particular, the CPU 500 may detect a location of the vehicle 104 as a network address on the network 102. The CPU 500 may also store the location of the vehicle 104 in the memory 502.

FIG. 1 also depicts a road I OS that is part of the network of roads in a geographic area. The vehicles 104a-d are shown to be traveling on the road 108. The vehicles 104 may be a car, a truck, a motorcycle, a boat, a bicycle, an autonomous or semi-autonomous vehicle. From vehicles 104a and 104c are shown to affect the rear vehicles 104b and 104d respectively with turbulent air flow 106a and 106b. Turbulent air flow 106a is shown to be less and/or smaller due to the distance between the vehicles 104a and 104b, and thus has a smaller drag effect on the rear vehicle 104b. Turbulent air flow 106b is shown to be more and/or larger due to the larger distance between the vehicles 104c and 104d. and thus has a larger drag effect on the rear vehicle 104d. Thus, in one exemplary embodiment, the V2V aerodynamics control manager 101 may decide to increase the aggregate aerodynamics between the two vehicles by reducing the distance between vehicles 104c and 104d by slowing down vehicle 104c and/or speeding up vehicle 104d.

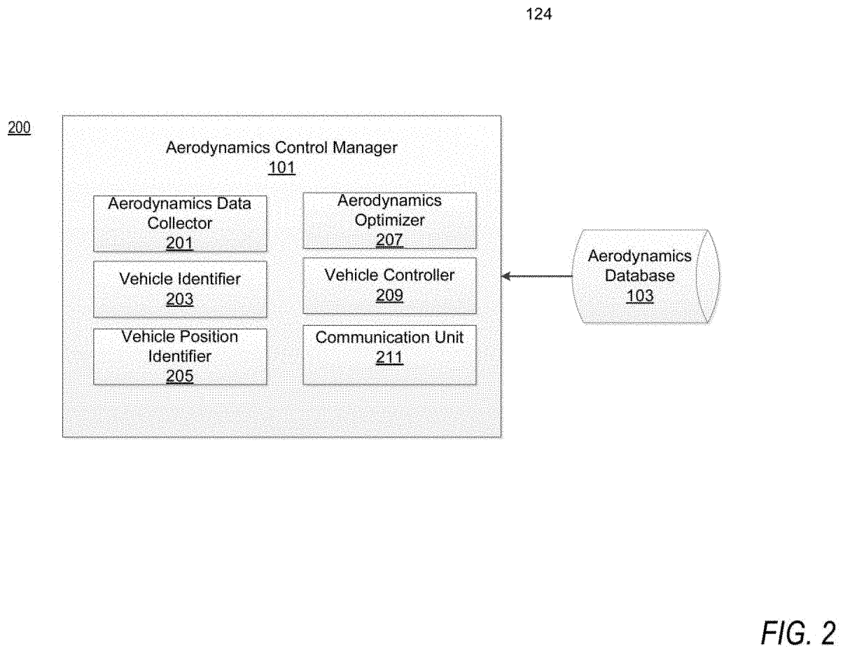

FIG. 2 is an exemplary block diagram of an aerodynamics control manager 101 of a V2V communication system for vehicle aerodynamics according to one exemplary embodiment. The an aerodynamics control manager 101 includes modules such as an aerodynamics data collector 201, vehicle identifier 203, vehicle position identifier 205, aerodynamics optimizer 207, vehicle controller 209 and communication unit 211. Each of the modules 201-209 may use the communication unit 211 to communicate with another vehicle, aerodynamics database 103, and/or among the modules 201-209. The modules described herein may be implemented as either software and/or hardware modules and may be stored in any type of computer-readable medium or other computer storage device. For example, each of the modules described herein may be implemented in circuitry that is programmable (e.g. microprocessor-based circuits) or dedicated circuits such as application specific integrated circuits (ASICS) or field programmable gate arrays (FPGAS). In one embodiment, a central processing unit (CPU) could execute software to perform the functions attributable to each of the modules described herein. The CPU may execute software instructions written in a programing language such as Java, C, or assembly. One or more software instructions in the modules may be embedded in firmware, such as an erasable programmable read-only memory (EPROM). Each module may work in conjunction with another module to accomplish their various tasks.

The aerodynamics data collector 201 may collect data from the communications, such as through common V2V communications: vehicle identity, speed, position, heading, control information (e.g., transmission status, braking status, steering). The aerodynamics data collector 201 may also collect information regarding the vehicle and surrounding vehicles through communications providing information about vehicle sensors, mechanically operated vehicle aerodynamics pans, vehicle size/shape/type, travel environment (e.g., weather, temperature, barometer, etc.), some of which may be collected from information in the aerodynamics database 103. In some embodiments, once the vehicle sensors are known, the sensor data may be accessed to collect data on nearby vehicle shapes/sizes/types for aerodynamics determinations. In some embodiments, the travel environment, such as weather, is collected from the Internet and/or vehicle sensors describing weather effects such as rain, wind, temperature, atmospheric pressure, and the like. The travel environment may affect the drag on vehicles in the environment based on additional wind, humidity, air density, etc.

The vehicle identifier 203 may determine, from the collected aerodynamics data and/or from the aerodynamics database 103 travel effects such as air flow/drag and environment, and aerodynamics data about the vehicle and nearby vehicles. The vehicle identifier 203 may also determine the available mechanically operated aerodynamics mechanisms for the vehicle. These mechanically operated aerodynamics mechanisms may include roof spoilers, trunk spoilers, wheel shutters, bumper air dams, body shields (e.g., skirts, fairings, etc.), vehicle vents, vehicle ducts, and the like. Additional information regarding the mechanically operated aerodynamics mechanisms may include operating ranges.

The vehicle position identifier 205 may determine, from the collected aerodynamics data, the vehicles which may communicate with one another based on V2V communications range limits. The vehicle position identifier 205 may also determine, based on the aerodynamics data, other vehicles which may affect the air flow around one another, for example, if the other vehicles are not able to communicate over the V2V communications. Further, based on the group of vehicles which affect the airflow around one another, the position of each vehicle in the group is determined. The position of each vehicle may be determined by the sensors on each vehicle, e.g., image analysis on cameras, RADAR/LIDAR data analysis, GPS of each vehicle, and/or wireless communication location determination technologies.

Based on the knowledge of the positioning of the vehicles, airflow determinations may be made which determine an initial state of flow. The initial state may be used to determine whether the aerodynamics of the group is in an optimized state. Further, based on what is known about the vehicles, the aerodynamics optimizer 207 may determine optimal positions for the vehicle and the mechanically operated aerodynamic mechanisms to increase individual vehicle and/or group aerodynamics from the initial state. The aerodynamics optimizer 207 then provides the vehicle controller 209 with the determined optimal positions and the vehicle controller 209 implements the changes to the vehicle and/or aerodynamic mechanisms. In one exemplary embodiment, the rear spoiler of a vehicle in a front position may be extended higher to provide better laminar flow to the group of vehicles traveling behind it and generate group optimized airflow which reduces aerodynamics of the front, vehicle, but increases the aerodynamics of the vehicles in the group. In another exemplary embodiment a vehicle traveling behind a semi-truck may reduce its profile by closing fairings, vents, or the like to increase its aerodynamics without affecting other vehicles in the group.

The aerodynamics optimizer 207 may also select between factors for optimization, for example, optimization of aerodynamics effecting fuel and/or power consumption, fuel and/or power consumption costs, and/or brake or other vehicle part life/consumption. In one exemplary embodiment, the optimization is simply for the cost of fuel and/or power within a group of vehicles. In another exemplary embodiment, the optimization is to aid the reduced fuel consumption of a vehicle with less fuel and/or power reserves (i.e., a vehicle initially lower on power and/or fuel). In another exemplary embodiment, the optimization is for reducing the use of expendable parts such as brakes based on the cost per use and/or cost by level of usage.

Additionally, in one exemplary embodiment, the aerodynamics optimizer 207 receives current data from the aerodynamics data collector 201 to continue to update and adjust the aerodynamics of the vehicle and/or group. For example, the aerodynamics optimizer 207 may determine to adjust the aerodynamics mechanisms by received data that the adjustments are having the wrong effect, i.e., resulting in less laminar How, the aerodynamics optimizer 207 will continue to adapt the aerodynamics mechanism to result in better aerodynamics of the vehicle.

Further, aerodynamics database 103 may collect aerodynamics settings and situations from the aerodynamics optimizer 207, which may later be used by the aerodynamics optimizer 207 in similar situations. For example, a vehicle traveling behind a semi-truck may use the same settings from a past situation where the vehicle travelled behind a similar size/shape semi-truck as an initial optimized setting for aerodynamics.

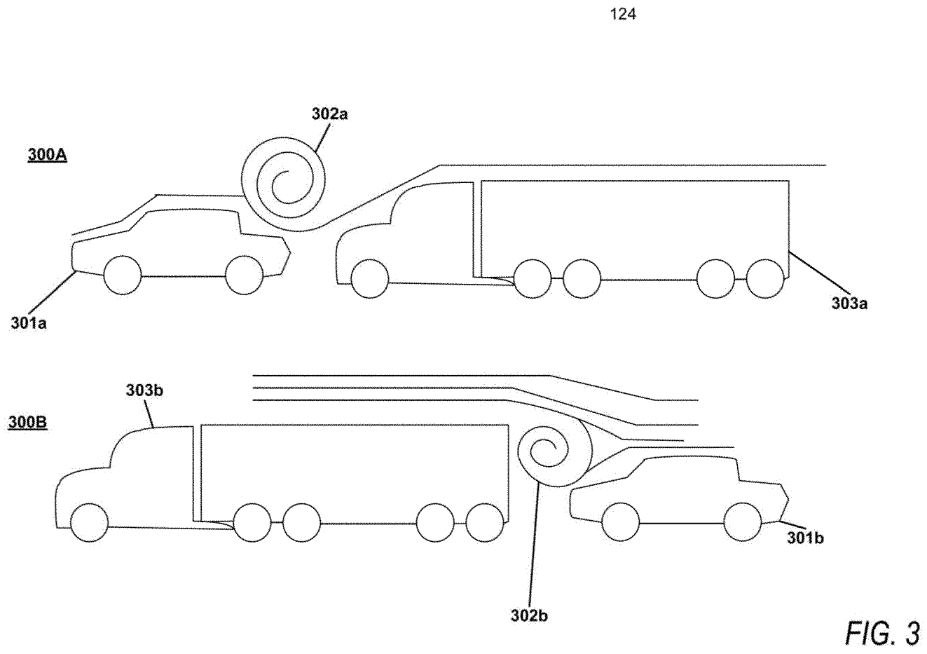

FIG. 3 is a diagram illustrating vehicle aerodynamics according to one exemplary embodiment. FIG. 3 illustrates how the position of vehicles may affect aerodynamics among a pair of vehicles 301 and 303. Specifically in a first scenario 300A, a smaller vehicle 301a is travelling ahead of a larger vehicle, e.g., a semi-truck 303a. The air flow 302a between the two vehicles is extremely turbulent. In a second scenario, a same or similar sized/shaped smaller vehicle 301b is travelling instead behind a same or similar sized/shaped larger vehicle 303b. Although the larger vehicle 303b becomes less aerodynamic, the effective change in aerodynamics of the larger vehicle 303b is much smaller than the change to the aerodynamics of the smaller vehicle 301b. Further, the turbulence of the air flow 302b between the two vehicles is smaller than the in the air flow of 302a.

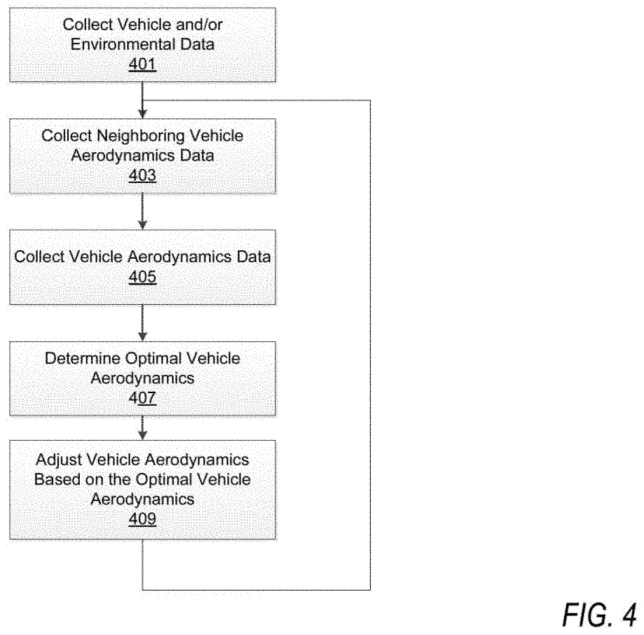

FIG. 4 is a diagram of a flowchart illustrating a flow of V2V communications for vehicle aerodynamics according to one exemplary embodiment. In step 401, V2V communications are used to collect vehicle and/or environmental data. The aerodynamics data collector 201 collects information about the surrounding vehicles via communications unit 211. Information from each vehicle within the V2V communications capabilities (i.e., communications over the DRSC), each vehicle within sensing distance, each vehicle effecting the vehicle's surrounding air flow, and/or each vehicle determined within a predetermined distance of the primary vehicle (i.e., the vehicle which initiates the V2V communications) is collected. The primary vehicle may include the server 101 or the server may be a part of the network 102. Further, based on the information collected about the vehicles, additional information about the vehicle from the Internet or a stored aerodynamics database 103. The information about the vehicle may include vehicle identification information, vehicle type, vehicle shape, the vehicle's sensors, the vehicle's mechanically adjustable aerodynamics components, and the like. The vehicle identifier 203 may use the vehicle identification information to determine additional information about the vehicle stored under the identifier within aerodynamics database 103.

Once known, the components of the vehicles, including sensors and adjustable aerodynamic components, may be used to determine aerodynamics of each vehicle. Specifically, in step 403, the V2V communications may be used to collect vehicle aerodynamics data either by request or automated shared communication by each of the vehicles. In one exemplary embodiment, the aerodynamics data collector 201 may receive, via the communication unit 211, identification information of the neighboring vehicles. The aerodynamics data collector may also collect aerodynamics information from particular sensors of other vehicles, such as strain gauges in a fairing and/or or pressure sensors collecting aerodynamics/drag information from the neighboring vehicles. Additionally, data regarding power usage of the vehicle and the like, which may indicate aerodynamics of the vehicle may be received. Vehicle aerodynamics data may also include historical data regarding the aerodynamics information.

The aerodynamics data collector 201 may also collect aerodynamics data of the neighboring vehicles through optical analysis of vehicles. The optical analysis may include analysis of video/image changes which may indicate aerodynamics, e.g., deflection of flexible parts of a vehicle which may indicate greater drag. Further, the optical analysis of neighboring vehicles may include si/e/shape determinations, often for vehicles which are incapable of providing vehicle identification information, and/or may often be modified with different size trailers and/or vehicle modifications. The size/shape determinations may provide analysis of the aerodynamics of a neighboring vehicle through known aerodynamics information or calculating aerodynamics of a vehicle based on the determined size shape of the vehicle.

Once the aerodynamics data collector 201 collects data about the aerodynamics of neighboring vehicles, in step 405 the aerodynamics data collector 201 may be used to collect aerodynamics of the primary vehicle by accessing the vehicle's own sensors to collect aerodynamics data. The aerodynamics data of the primary vehicle may be collected in a similar manner to the neighboring vehicle aerodynamics, by collecting aerodynamics data from vehicle sensor data and based on the know n vehicle identification information regarding the primary vehicle to calculate aerodynamics of the vehicle.

In step 407, the aerodynamics optimizer 207 uses the data collected from the aerodynamics data collector 201 to determine optimal vehicle aerodynamics for the primary and neighboring vehicles as a group. In some embodiments the aerodynamics optimizer 207 may also simply determine optimal aerodynamics for the primary vehicle while holding the other vehicles unchanged. In some embodiments the optimization determination is made with respect to different factors set by a user of the primary vehicle. These factors may include one or more of the optimization of aerodynamics effecting the efficiency of fuel and/or power consumption, fuel and/or power consumption costs, and/or brake or other vehicle part life consumption of each vehicle and or overall of the group. The aerodynamics optimizer 207, based on these optimization factors and the known and mechanically operated aerodynamics mechanisms, may determine an optimal aerodynamics setting for each vehicle

In some embodiments, the aerodynamics optimizer 207 may also select other methods to increase the aerodynamics of the vehicles, such as by changing or adjusting the positions of the vehicle(s) within the group. With increased use of autonomous vehicles more vehicles using the V2V communications may provide control to all the autonomous controls of the vehicles including steering, throttle, braking, etc. Thus, the aerodynamics optimizer 207, in these embodiments, will be capable of control over vehicle transmission, speed, braking, steering, etc. to change or adjust the positioning of the vehicles. Each of the control capabilities of the vehicles in the group may be evaluated to determine how/whether the vehicle positions may be changed or adjusted. Vehicles that the V2V communications system cannot control are assumed to generally maintain their current course and speed, thus the aerodynamics optimizer 207 considers which vehicles it may change adjust position to increase the overall aerodynamics of the vehicles in the group. Position change may require steering and speed-throttle control over the vehicles to change order of the vehicles to provide better aerodynamics to most or all of the vehicles. Whereas, position adjustment may simply require a speed/throttle control over the vehicles to have the vehicles remain in the same order but adjust distance between the vehicles.

These changes/adjustments may be prioritized or selected by users as a solution to increasing aerodynamics. For example, the user may be prompted to select a position adjustment or change with respect to the other vehicles, as well as, changes to the adjustable aerodynamics components. In other embodiments, the user may select a priority of changing the adjustable aerodynamics components over changes/adjustment to positioning of the vehicle. However, in some embodiments, unless position adjustment/change is not selected as a solution to increasing aerodynamics, the aerodynamics optimizer 207 may determine that a position adjustment may provide greater increase in aerodynamics than changes to the adjustable aerodynamics components and thus the aerodynamics optimizer 207 would include the position adjustment as an optimal aerodynamics setting.

Once the aerodynamics optimizer 207 determines the optimal aerodynamics setting, in step 409, the vehicle controller 209 adjusts each of the mechanically operated aerodynamics mechanisms to the determined optimal aerodynamics setting. The aerodynamics control manager 101 may continue to collect aerodynamics information to iteratively optimize the aerodynamics of the primary vehicle and or group and learn to self-adjust aerodynamics settings to continue to optimize aerodynamics.

Next, a hardware description of the server 101 according to exemplary embodiments is described with reference to FIG. 5. In FIG. 5, the server 101 includes a CPU 500 which performs the processes described above/below. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 100 communicates, such as a server or computer.

Further, the claimed advancements may be provided as a utility application, background daemon, or component of an operating system, or combination thereof, executing in conjunction with CPU 500 and an operating system such as Microsoft Windows 7, UNIX. Solaris, LINUX, Apple MAC-OS and other systems known to those skilled in the art.

In order to achieve the server 100, tire hardware elements may be realized by various circuitry elements, known to those skilled in the art. For example, CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The server 101 in FIG. 5 also includes a network controller 506, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wired, such as an Ethernet network, or can be wireless such as a cellular network including EDGE, 3G and 4G wireless cellular systems. The wireless network can also be WiFi, Bluetooth, or any other wireless form of communication that is known.

The general purpose storage controller 524 connects the storage medium disk 504 with communication bus 526, which may be an ISA, EISA, VESA, PCI or similar, for interconnecting all of the components of the server 100. A description of the general features and functionality of the display 510, keyboard and or mouse 514, as w ell as the display controller 508, storage controller 524, network controller 506, sound controller 520, and general purpose I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in the circuitry on a single chipset.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A vehicle to vehicle aerodynamics adjustment system comprising:
a processor of a vehicle configured to
communicate over a vehicle to vehicle (V2V) communications system;
determine vehicle information;
share aerodynamics information and vehicle information of the vehicle;
determine an aerodynamics setting based on the aerodynamics information and the vehicle information; and
adjust the vehicle based on the aerodynamics setting.

2. The vehicle to vehicle aerodynamics adjustment system according to claim 1, wherein the processor of the vehicle is further configured to:
receive neighboring vehicle information and neighboring vehicle aerodynamics information; and
determine the aerodynamics setting based on the aerodynamics information, the vehicle information, the neighboring vehicle information, and the neighboring vehicle aerodynamics information.

3. The vehicle to vehicle aerodynamics adjustment system according to claim 1, wherein the processor of the vehicle is further configured to:
share updated aerodynamics information after adjustment of the vehicle;
receive updated neighboring vehicle aerodynamics information; and
determine an updated aerodynamics setting based on the updated aerodynamics information, the updated neighboring vehicle aerodynamics information, and the vehicle information.

4. The vehicle to vehicle aerodynamics adjustment system according to claim 1, wherein the vehicle information comprises vehicle identity information, vehicle sensor information, mechanically operated vehicle aerodynamics part information, current vehicle operation information, vehicle type, vehicle size and shape, and vehicle location information.

5. The vehicle to vehicle aerodynamics adjustment system according to claim 4, wherein the aerodynamics information comprises vehicle travel environment information based on the vehicle location information, sensor data collected from the vehicle sensors described by the vehicle sensor information, and determined from the vehicle size and shape.

6. The vehicle to vehicle aerodynamics adjustment system according to claim 1, wherein the adjustment of the vehicle includes at least one of adjusting the setting of at least one mechanically operated vehicle aerodynamics part and vehicle operations.

7. The vehicle to vehicle aerodynamics system according to claim 6, wherein the vehicle operations include throttle control, speed control, steering control, transmission control, and braking.

8. A vehicle to vehicle aerodynamics adjustment method comprising:
communicating over a vehicle to vehicle (V2V) communications system:
determining vehicle information;
sharing aerodynamics information and vehicle information of the vehicle;
determining an aerodynamics setting based on the aerodynamics information and the vehicle information; and
adjusting the vehicle based on the aerodynamics setting.

9. The vehicle to vehicle aerodynamics adjustment method according to claim 8, further comprising:
receiving neighboring vehicle information and neighboring vehicle aerodynamics information; and
determining the aerodynamics setting based on the aerodynamics information, the vehicle information, the neighboring vehicle information, and the neighboring vehicle aerodynamics information.

10. The vehicle to vehicle aerodynamics adjustment method according to claim 8, further comprising:
sharing updated aerodynamics information after adjustment of the vehicle;
receiving updated neighboring vehicle aerodynamics information; and
determining an updated aerodynamics setting based on the updated aerodynamics information, the updated neighboring vehicle aerodynamics information, and the vehicle information.

11. The vehicle to vehicle aerodynamics adjustment method according to claim 8, wherein the vehicle information comprises vehicle identity information, vehicle sensor information, mechanically operated vehicle aerodynamics part information, current vehicle operation information, vehicle type, vehicle size and shape, and vehicle location information.

12. The vehicle to vehicle aerodynamics adjustment method according to claim 11, wherein the aerodynamics information comprises vehicle travel environment information based on the vehicle location information, sensor data collected from the vehicle sensors described by the vehicle sensor information, and determined from the vehicle size and shape.

13. The vehicle to vehicle aerodynamics adjustment method according to claim 8, w herein the adjustment of the vehicle includes at least one of adjusting the setting of at least one mechanically operated vehicle aerodynamics part and vehicle operations.

14. The vehicle to vehicle aerodynamics adjustment method according to claim 13, wherein the vehicle operations include throttle control, speed control, steering control, transmission control, and braking.

15. A non-transitory storage computer readable medium including programming instructions for:
communicating, with processing circuitry, over a vehicle to vehicle (V2V) communications system;
determining, with the processing circuitry, vehicle information;
sharing, with the processing circuitry, aerodynamics information and vehicle information of the vehicle;
determining, with the processing circuitry, an aerodynamics setting based on the aerodynamics information and the vehicle information; and
adjusting, with the processing circuitry, the vehicle based on the aerodynamics setting.

16. The non-transitory computer readable medium according to claim 15, further comprising instructions for:
receiving, with the processing circuitry, neighboring vehicle information and neighboring vehicle aerodynamics information; and
determining, with the processing circuitry, the aerodynamics setting based on the aerodynamics information, the vehicle information, the neighboring vehicle information, and the neighboring vehicle aerodynamics information.

17. The non-transitory computer readable medium according to claim 15, further comprising instructions for:
sharing, with the processing circuitry, updated aerodynamics information after adjustment of the vehicle;
receiving, with the processing circuitry, updated neighboring vehicle aerodynamics information; and
determining, with the processing circuitry, an updated aerodynamics setting based on the updated aerodynamics information, the updated neighboring vehicle aerodynamics information, and the vehicle information.

18. The non-transitory computer readable medium according to claim 15, wherein the vehicle information comprises vehicle identity information, vehicle sensor information, mechanically operated vehicle aerodynamics part information, current vehicle operation information, vehicle type, vehicle size and shape, and vehicle location information.

19. The non-transitory computer readable medium according to claim 18, wherein the aerodynamics information comprises vehicle travel environment information based on the vehicle location information, sensor data collected from the vehicle sensors described by the vehicle sensor information, and determined from the vehicle size and shape.

20. The non-transitory computer readable medium according to claim 15, wherein the adjustment of the vehicle includes at least one of adjusting the setting of at least one mechanically operated vehicle aerodynamics part and vehicle operations.
